(19) United States
(12) Patent Application Publication
(10) Pub. No.: US 2006/0071638 A1
(43) Pub. Date: Apr. 6, 2006

(54) Bottom exit strain relief

(75) Inventor: Jeffrey Sean Jones, Hartselle, AL (US)

Correspondence Address: BRINKS HOFER GILSON & LIONE, P.O. BOX 10395, CHICAGO, IL, 60610, US

(73) Assignee: ONE WORLD TECHNOLOGIES LIMITED

(21) Appl. No.: 10/954,879

(22) Filed: Sep. 30, 2004

(51) Int. Cl. H02J 7/00

(52) U.S. Cl. 320/114

(57) ABSTRACT

A charging unit for charging a battery of a power tool containing a base with a cavity defined by a side wall and a top wall, at least one protrusion extending from one of the side wall or the top wall, a cord, and a strain relief positioned around the cord and located within the cavity. The cord may be wrapped around the at least one protrusion, thereby providing flexibility in the direction of the cord and a means for eliminating excess cord between the charging unit and the electrical outlet when the unit is in operation. The base may also include a slot to receive and stabilize the cord. In addition, a method is provided for providing flexibility in the direction of the cord in a charging unit. The method includes providing an article having a cord, a cavity with a top wall, and at least one protrusion extending from one of the side wall or the top wall; and wrapping the cord around the at least one protrusion.

### BACKGROUND

The present invention relates to charging units, such as units suitable for charging the battery of a cordless power tool, and to methods for providing flexibility in the direction of the cord in such charging units.

Many electronic articles, such as cordless power tools, use a rechargeable battery. When an electronic article is repeatedly used, the battery becomes discharged, and a charging unit is required to restore the charge to the battery. Such a recharging unit is generally adapted to accommodate either the battery by itself or the combination of the battery and the article to which it is attached.

To eliminate the strain on the cord through which the charging current is fed to the battery, conventional charging units include a strain relief device on the cord. Such strain relief devices prolong the life of the electronic article by preventing damage to the cord when it is repeatedly repositioned, pulled, compressed, or otherwise abused. Strain relief devices absorb the forces that could threaten the integrity of the cord and cause loss of functionality, as well as safety hazards. Examples of strain relief devices are set forth in U.S. Pat. Nos. 6,478,609; 6,488,317; and 6,706,970.

In conventional charging units, the strain relief device is located on one side of the charging unit. The rigidity of the strain relief prevents easy repositioning of the cord to a desired orientation. Instead, to place the cord in the desired orientation, the entire charging unit must be repositioned. Repositioning only the cord in the conventional charging unit could result in damage to and disruption of the charging operation by overturning the charging unit or disconnecting the battery from the unit.

Another problem with conventional charging units is their unwieldiness when stored. Typically, the cord of such units is wrapped around the body of the unit when the unit is not in use. The bulkiness of the unit results in the need for additional storage space. Moreover, the cord usually becomes unwrapped and gets tangled with itself and other items in the vicinity of the unit.

Prior attempts to alleviate these problems include wrapping the cord around a device separate from the charging unit (see e.g., U.S. Pat. Nos. 3,371,260 and 5,939,858). This attempted solution, however, adds to the bulkiness of the charging unit and results in an unsightly coil of cord wrapped around the separate device.

Therefore, there is a need for a charging unit in which the cord may be positioned in any desired orientation without damaging or disrupting the operation of the charging unit. In addition, there is a need for a charging unit that eliminates the problems of bulkiness and unwieldiness when stored. There is also a need for a method for providing flexibility in the direction of the cord in such charging units.

### SUMMARY

One aspect of the present invention is directed to a charging unit containing a base with a cavity defined by a side wall and a top wall, at least one protrusion extending from one of the side wall or the top wall of the base, a cord, and a strain relief positioned around the cord and located within the cavity in the base. The cord may be wrapped around the at least one protrusion, thereby providing flexibility in the direction of the cord and a means for eliminating excess cord between the charging unit and the electrical outlet when the unit is in operation.

Desirably, the base is adapted to receive a battery of a power tool, and the at least one protrusion has a laterally extending portion to aid in preventing the cord from slipping off the protrusion and a height sufficient to create a gap between the base of the charging unit and the surface upon which the unit is placed, providing clearance for the cord and the flexibility to extend the cord from any side of the base. The base may also include a slot adapted to receive and stabilize the cord.

Another aspect of the present invention is directed to a method for providing flexibility of the direction of the cord in a charging unit. The method includes providing an article having a base with a cavity defined by a side wall and a top wall, where at least one protrusion extends from one of the side wall or the top wall and into the cavity; and wrapping the cord around the at least one protrusion. The method may also include positioning the cord so that it extends beneath any side of the article or inserting the cord into a slot located on any side of the article. The article may then be mounted on any flat surface without the inconvenience of rigid cord directioning or excess cord between the charging unit and the electrical outlet.

### BRIEF DESCRIPTION OF THE DRAWINGS

FIG. 1 shows a front view of one embodiment of the present invention.

FIG. 2 shows a side view of another embodiment of the present invention, including a slot through which the cord may be placed.

FIG. 3 shows a top view of the embodiment depicted in FIG. 1.

FIG. 4 shows a bottom view of the embodiment depicted in FIG. 1.

### DESCRIPTION

One aspect of the present invention is directed to a charging unit 10 having a base 12 with a cavity 40 defined by a side wall 38 and a top wall 42, at least one protrusion 14 extending from one of the side wall 38 or the top wall 42 into the cavity 40, a cord 18, and a strain relief 20 positioned around the cord 18 and located within the cavity 40. Any suitable and known material may be used to form the base 12 and strain relief 20. For example, the base may be formed from metal or plastic. Likewise, any suitable and known material may be used to form the power cord 18. For example, the cord 18 may contain a core having continuous strands of rubber and a jacket made from an abrasion resistant material such as polyester, nylon, or polypropylene.

Placement of the strain relief 20 within the cavity 40 allows the cord 18 to be extended from any side wall 38 of the base 12. In addition, this placement of the strain relief 20 allows the cord 18 to be wrapped around the at least one protrusion 14, thereby reducing any slack in the cord 18 when the cord 18 is plugged into an electrical outlet, which supplies electric current to the charging unit 10 when in use.

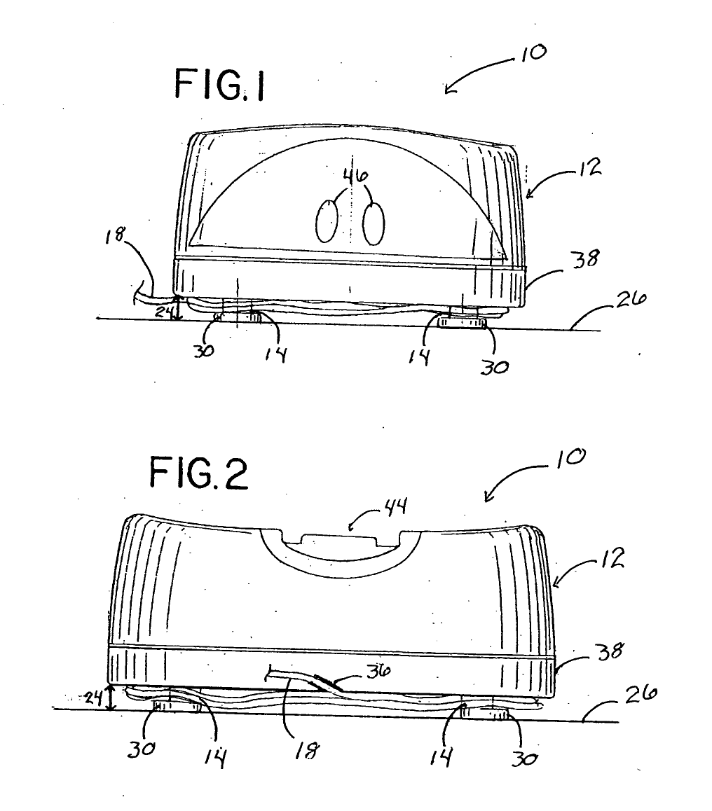

In one embodiment of the present invention, the cord 18 is wrapped around the protrusion in the charging unit 10. The protrusion may serve a dual function. It may serve as a structure around which the cord 18 may be wrapped, as well as a housing for the operative components of the charging unit 10. In one embodiment shown in FIG. 2, the protrusion 14 extends from the top wall 42 toward the surface 26 upon which the unit 10 is placed. The protrusion 14 may have a height sufficient to create a gap 24 between the base 12 and the surface 26 upon which the charging unit 10 is placed. This gap 24 provides sufficient clearance for the cord 18 to be wrapped around the protrusion and extended beneath any side of the base. The cord 18 may then be plugged into any outlet without repositioning the entire charging unit 10. In addition, the cord 18 may be wrapped around the protrusion 14 as many times as necessary to reduce the length of cord 18 between the charging unit 10 and the outlet. Reducing the length of cord 18 in this manner minimizes the unsightliness of the cord 18 and reduces the likelihood that someone will trip over the excess cord 18 or that the cord 18 will get tangled with itself or other items.

In another embodiment, the top wall 42 contains two protrusions 14 around which the cord 18 may be wrapped. The protrusions 14 may have any shape suitable to removably receive, support, and secure the cord 18. One desired shape is arcuate, but the protrusions may also have a rectangular or bent shape, for example. In an alternate embodiment, such as the one shown in FIG. 4, the top wall 42 contains four foot-like protrusions 14. The protrusions 14 may be attached to the top wall 42 in any suitable manner, such as by the use of adhesive or screws or by being integrally molded with the base 12. Desirably, the protrusions 14 include a laterally extending portion 30 for preventing the cord 18 from slipping off the protrusions. Further, a non-stick covering, such as a rubber pad, may be attached to the bottom portion of the protrusion(s) 14 or the bottom portion of the laterally extending portion(s) 30 of the protrusion(s) 14 to prevent slipping of the charging unit 10 on the surface 26 upon which it is placed.

In another embodiment, the protrusion(s) 14 are located on the side wall 38 of the base 12. For example, the protrusion 14 may comprise a straight portion extending from the side wall 38 and a portion perpendicular to the straight portion. The cord 18 may then be wrapped around the protrusion 14 and retained in place by the perpendicular portion of the protrusion 14. The protrusions 14 may have any shape suitable to removably receive, support, and secure the cord 18.

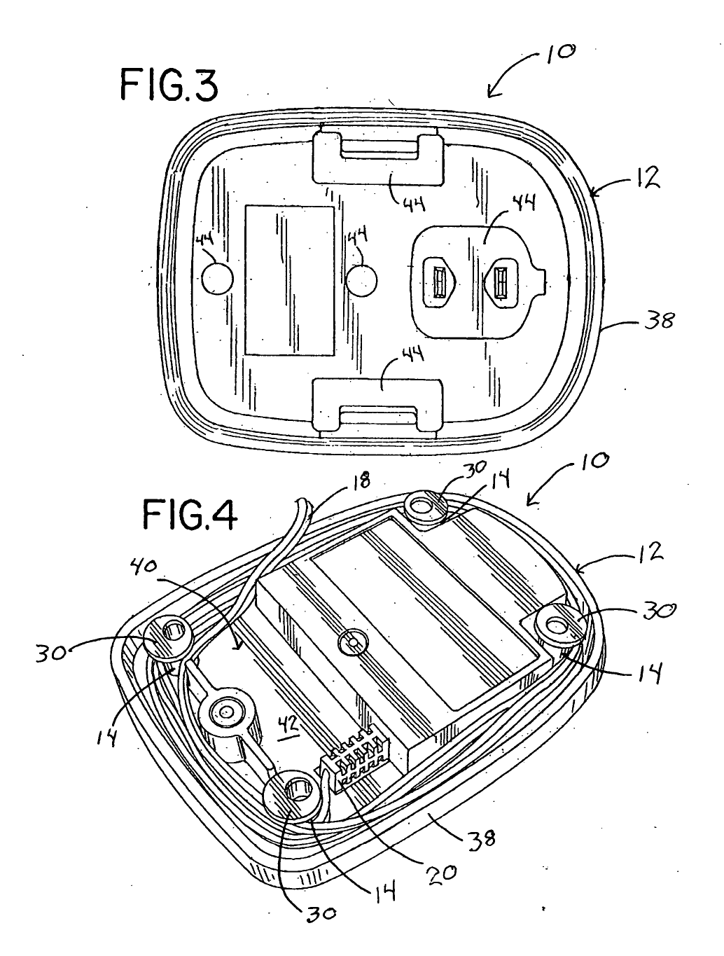

In yet another embodiment, the base 12 of the charging unit 10 is adapted to receive a battery of a power tool or the combination of a power tool with a battery connected to it (not shown). The recesses 44 adapted to receive a battery (or a power tool and battery combination) may be as shown in FIG. 3. Any other suitable configuration may also be used for receiving the article to be charged. Moreover, the charging unit 10 may include status lights 46, as shown in FIG. 1, for indicating when the battery is being charged and when the charging process is complete.

The charging unit 10 may also contain at least one slot 36 provided in one or more of its sides. The cord 18 may then pass through the slot 36. Although assuring that there is a sufficient gap 24 between the base 12 of the charging unit 10 and the surface upon which it rests 26 will accomplish the objective of eliminating strict cord directioning without the need for a slot 36 in the base 12, including such a slot 36 will serve the additional function of stabilizing the cord 18.

Another aspect of the present invention is directed to a method for providing flexibility in the direction of a cord 18 in a charging unit 10, such as a charging unit 10 adapted to receive a battery (not shown) of a power tool. The method includes: providing an article having a base 12 with a cavity 40 defined by a side wall 38 and a top wall 42, where at least one protrusion 14 extends from one of the side wall 38 or the top wall 42 and into the cavity 40; and wrapping the cord 18 around the at least one protrusion 14. The method may also include positioning the cord 18 so that it extends beneath any side wall 38 of the article or passing the cord 18 through a slot 36 located on any side wall 38 of the article. This method eliminates the inconvenience of rigid cord directioning or excess cord 18 between the charging unit 10 and the electrical outlet providing current to the unit 10 when in use.

In another embodiment, the method of the present invention includes mounting the article on a flat surface 26 and plugging the cord 18 into an outlet. The article may be mounted on a vertical surface or a horizontal surface, for example. Desirably, the at least one protrusion 14 is an arcuate protrusion having a height sufficient to create a gap 24 between the base 12 of the charging unit 10 and the surface 26 upon which the unit 10 is placed so that the cord 18 can be wrapped around the protrusion(s) 14 and then extended from any side 38 of the unit without upsetting the unit 10 or disrupting its operation.

In yet another embodiment, the method of the present invention includes placing the cord 18 through a slot 36 located on any or all of the sides 38 of the charging unit 10. This placement of the cord 18 stabilizes the cord 18 by maintaining the tension of the cord 18 wrapped around the protrusion(s) 14 and reduces the likelihood that the cord 18 will come unraveled during the charging operation or during storage.

Of course, it should be understood that a wide range of changes and modifications could be made to the embodiments described above. It is therefore intended that the foregoing detailed description be regarded as illustrative rather than limiting, and that it be understood that it is the following claims, including all equivalents, that are intended to define the spirit and scope of this invention.

What is claimed:

1. A charging unit comprising
a. a base with a cavity defined by a side wall and a top wall;
b. at least one protrusion extending from one of the side wall or the top wall into the cavity;
c. a cord; and
d. a strain relief positioned around the cord and located within the cavity;
wherein the cord may be wrapped around the at least one protrusion.

2. The charging unit of claim 1 wherein the base is adapted to receive a battery of a power tool.

3. The charging unit of claim 2 wherein the protrusion extends from the top wall.

4. The charging unit of claim 2 wherein the protrusion extends from the side wall.

5. The charging unit of claim 1 wherein the at least one protrusion comprises a laterally extending portion.

6. The charging unit of claim 1 wherein the at least one protrusion has a height sufficient to define a gap between the side wall and a surface upon which the base is placed.

7. The charging unit of claim 1 further comprising a slot in a side of the base, the slot being adapted to receive the cord.

8. The charging unit of claim 1 comprising two protrusions.

9. The charging unit of claim 1 comprising four protrusions.

10. The charging unit of claim 1 wherein an end of the cord opposite the strain relief is extendable from the side wall.

11. A battery charger comprising
a. a base with a cavity defined by a side wall and a top wall, the base being adapted to receive a battery of a power tool;
b. at least one protrusion extending from the top wall toward a surface upon which the base is placed;
c. at least one slot in the side wall of the base;
d. a cord; and
e. a strain relief positioned around the cord and located within the cavity;
wherein the cord may be wrapped around the at least one protrusion.

12. The battery charger of claim 11 wherein the at least one protrusion comprises a laterally extending portion.

13. The battery charger of claim 12 wherein the at least one protrusion has a height sufficient to define a gap between the side wall and a surface upon which the base is placed.

14. A method for providing flexibility in the direction of the cord in a charging unit, the method comprising:
a. providing an article having a base with a cavity defined by a side wall and a top wall, wherein at least one protrusion extends from one of the side wall or the top wall into the cavity; and
b. wrapping the cord around the at least one protrusion.

15. The method of claim 14 further comprising positioning the cord so that it extends beneath a side wall of the article.

16. The method of claim 14 further comprising inserting the cord into a slot located on the side wall of the article.

17. The method of claim 14 further comprising mounting the article on a horizontal surface.

18. The method of claim 14 wherein the charging unit is adapted to receive a battery of a power tool.
